(19) United States
(12) Patent Application Publication
(10) Pub. No.: US 2020/0331158 A1
(43) Pub. Date: Oct. 22, 2020

(54) ATTACHMENT FOR A PERSONAL CARE DEVICE

(71) Applicant: KONINKLIJKE PHILIPS N.V., Eindhoven (NE)

(72) Inventors: Jarno STREUR, Eindhoven (NL); Johannes Hendrikus van TOOR, Eindhoven (NL)

(73) Assignee: Koninklijke Philips N.V., Eindhoven (NE)

(21) Appl. No.: 16/305,274

(22) PCT Filed: May 26, 2017
(86) PCT No.: PCT/EP2017/062768

§ 371 Date: Nov. 28, 2018

(30) Foreign Application Priority Data
May 31, 2016 (EP) 16172238.4

(51) Int. Cl. B26B 19/38; B26B 19/14

(52) U.S. Cl. CPC B26B 19/3813; B26B 19/14; B26B 19/386

(57) ABSTRACT

The invention relates to an attachment (2) for a personal care device (1), such as a shaving or trimming device. The attachment (2) is adapted to be releasably coupled to a coupling structure (11) of the personal care device by means of a coupling member (10). The coupling member (10) comprises a shaft-like element (6) having at least one coupling recess (7) on the circumferential surface (8) thereof. This coupling recess (7) has a central portion and first and second side portions (18, 20) arranged on opposite sides of the central portion. It comprises a sloped surface (15) arranged in at least the central portion. When the attachment (2) is coupled to the coupling structure (11), the sloped surface is engaged by a spring of the coupling structure (11). At least one of the first and second side portions (18, 20) of the coupling recess (7) is recessed relative to the sloped surface (15), seen in a direction parallel to the central axis (13) of the shaft-like element (6). As a result, the risk of unintentional release of the attachment (2) from the coupling structure (11) is reduced as compared to known devices, whereas the removal by means of an intended central pulling-off force is not significantly affected.

### FIELD OF THE INVENTION

The present invention relates to an attachment for a personal care device, and in particular to an attachment which can be releasably coupled to a coupling structure of a main housing of the personal care device.

### BACKGROUND OF THE INVENTION

Personal care devices comprising a releasably mounted attachment include shavers, trimmers, and massagers. In such devices, the attachment can e.g. be released and replaced by a different attachment for changing the functionality of the personal care device. For such devices, it is important to ensure that the attachment can be easily mounted on and released from the main housing or base part of the personal care device by the user. At the same time the device should be designed such that the attachment is neither so loosely mounted that it can be unintentionally released during use of the device nor so firmly mounted that it could be damaged in case of an overloading force, e.g. in case of an accidental fall of the device.

WO2008/062339 discloses a rotary shaver with a support structure for shaving heads, which ensures that the shaving head is releasably mounted in a manner such that it is more effectively protected against damage in case of an overloading force than previously known shavers. The shaving head as disclosed in this patent application comprises a shaft-like element to be retained in a retaining recess of a base part of the shaver. The releasable coupling is established between a spring element arranged in the retaining recess and sloped surfaces of two coupling recesses provided in a circumferential surface of the shaft-like element. With an attachment of this kind, the application of a pulling force at a location on the attachment off-center from a central axis of the shaft-like element may in some cases result in unintentional release of the attachment from the retaining recess, in particular during use. This is particularly the case if such an off-center pulling force is applied at a position on an imaginary plane extending through the central axis of the shaft-like element and being substantially parallel to the two legs of the spring element. Such a pulling force will result in a tilting of the whole attachment, which causes the legs of the spring element to start gliding off the sloped surface at the side portion of the sloped surface where the depth of the coupling recess is relatively small as a result of the convex shape of the circumferential surface of the shaft-like element, and to further glide off via the edge between the sloped surface and the circumferential surface. In case of an intended central pulling force, i.e. a pulling force exerted at the location of the central axis of the shaft-like element and parallel to the central axis, the gliding off of the legs of the spring element will be more uniform over the whole sloped surface of the coupling recess, so that the central portion of the sloped surface, where the recess has the largest depth, fully contributes to the resistance against the gliding off of the legs of the spring element. So, in case of an off-center pulling force, the attachment can be released from the base part too easily, i.e. with too little force. This will be explained in further detail in relation to the figures.

Thus, the inventors of the present invention have appreciated that an improved attachment for a personal care device, such a shaver, is of benefit, and have in consequence devised the present invention.

### SUMMARY OF THE INVENTION

It would be advantageous to achieve an attachment for a personal care device with which the risk of an unintended release of the attachment from the main housing or base part of the device is lower than with known devices. Furthermore, it would be advantageous to achieve an attachment such that the removal thereof by an intended central pulling-off force is not significantly affected. In particular, it would be advantageous to achieve an attachment with which both of these advantages can be obtained in combination. In general, the invention preferably seeks to mitigate, alleviate or eliminate one or more of the above mentioned disadvantages of the known devices singly or in any combination. In particular, it may be seen as an object of the present invention to provide an attachment for a personal care device that solves the above mentioned problems, or other problems, of the prior art devices.

To solve one or more of these problems, in a first aspect of the invention, an attachment for a personal care device is presented, the attachment comprising:
at least one treatment member for performing a treatment action, and
a coupling member for releasably coupling the attachment to a coupling structure of a main housing of the personal care device, wherein
the coupling member comprises a shaft-like element:
   having a circumferential surface and a central axis,
   protruding from the attachment in a direction away from the at least one treatment member, and
   comprising at least one coupling recess arranged in a portion of the circumferential surface which is convex at least when seen in a cross-section of the shaft-like element perpendicular to the central axis,
      and wherein
the at least one coupling recess, when seen in the cross-section of the shaft-like element perpendicular to the central axis, has a central portion and first and second side portions arranged on opposite sides of the central portion and each extending from the central portion up to an end point of the coupling recess, and
the at least one coupling recess comprises a sloped surface arranged in at least the central portion, said sloped surface being inclined towards the treatment member seen in a direction from the circumferential surface towards the central axis,
   and wherein
at least one of the first and second side portions of the coupling recess is recessed relative to the sloped surface, seen in a direction parallel to the central axis.

By “sloped surface” is preferably meant a surface that is arranged inclined or with a curve in relation to the central axis of the shaft-like element. As will be explained in further detail below, the engagement between the sloped surface and at least one spring element of the coupling structure should be such that it causes a spring force component of the spring element to retain the coupling member in a fixed position in a retaining recess of the coupling structure. As a result, a releasable coupling is obtained. The fact that the surface which engages with the spring element is sloped, enables the spring element to release from the recess when a pulling force, preferably parallel to the central axis of the shaft-like element, is exerted on the attachment to release the attachment from the coupling structure of the main housing. Such a pulling force causes the spring element to glide off the sloped surface under deformation of the spring element. This kind of fastening mechanism is typically referred to as a snap connection, as will be more clearly seen from the figures.

If desired, a coupling recess could comprise more than one sloped surface, such as two sloped surfaces arranged next to each other.

By “central portion” in relation to the coupling recess is preferably meant the region near the middle of the coupling recess where the distance between the circumferential surface of the shaft-like element and the innermost edge of the coupling recess, i.e. closest to the central axis, is largest as a result of the convex shape of the circumferential surface of the shaft-like element, i.e. the region near the middle of the coupling recess where the coupling recess has its largest depth. For a symmetrically shaped recess, this will be the region around the axis of symmetry of the coupling recess.

The feature that “at least one of the first and second side portions of the coupling recess is recessed relative to the sloped surface seen in a direction parallel to the central axis” also includes embodiments wherein the recession of the first and/or the second side portion relative to the sloped surface, seen in the direction parallel to the central axis, extends to a lower end of the shaft-like element such that the coupling recess at these side portions and at positions near the end of the recess facing away from the treatment member is not limited by a surface of the shaft-like element. Examples of such embodiments are shown in FIGS. 8d, 8e, and 8f.

The sloped surface could be recessed relative to the circumferential surface of the shaft-like element, i.e. seen in a direction from the central axis of the shaft-like element towards the circumferential surface, the sloped surface may not fully extend up to the circumferential surface. A possible purpose of such a recessed sloped surface could be to obtain an outermost edge of the sloped surface which is less prone to damage caused by the engagement with the spring elements. Another possible purpose of such a recessed sloped surface could be to influence the forces to be applied for mounting or releasing the attachment in order to provide the user with a desired ease of use of the device. The exact shape of the at least one coupling recess can be determined during the design process, also taking into account certain parameters to be described in the following.

By arranging at least one of the first and second side portions of the coupling recess in a recessed position relative to the sloped surface, seen in a direction parallel to the central axis, it is ensured that, in the coupled condition of the attachment, at least one of the side portions does not engage with the spring element of the coupling structure of the main housing. As a result, the sloped surface, and in particular the central portion where the coupling recess has its largest depth, plays a more dominant role in the engagement with the spring element in case of an off-center pulling force. In particular, by the recessed position of at least one of the first and second side portions of the coupling recess, the disadvantageous gliding-off of the spring element via the narrow side portions of the sloped surface of known devices is prevented at the location of the recessed side portions.

The central portion of the coupling recess is the part of the coupling recess where the depth of the coupling recess in radial direction relative to the central axis of the shaft-like element is largest, i.e. where the distance along which the spring element has to deform in said radial direction in order to release the attachment is largest. Besides the larger depth of the central portion of the coupling recess, the resulting retaining force is controlled in a more defined way by the geometry of the coupling recess according to the invention, which also results in a higher retaining force compared to existing solutions. Since the sloped surface in the central portion of the coupling recess plays a dominant role in the engagement with the spring element of the coupling structure of the main housing, the resistance against unintentional release is largest, as explained above.

In a preferred embodiment of the invention, the sloped surface is bordered by an edge at each location where the sloped surface borders a respective one of the first and second side portions that are recessed relative to the sloped surface, said edge being directed inwardly seen from the circumferential surface. By “inwardly” is preferably meant in a direction towards a central region of the shaft-like element, wherein the central region comprises the central axis. In this embodiment, the recessed side portion may be made by providing a step relative to the sloped surface, i.e. by lowering the side face, by removing the side face starting from the edge, or by rotating the side face starting from the edge.

In an embodiment of the invention, the at least one coupling recess is symmetrically shaped relative to an imaginary plane of symmetry comprising the central axis of the shaft-like element, the first and second side portions being both recessed relative to the sloped surface seen in the direction parallel to the central axis. In this embodiment, the sloped surface is located centrally with respect to the axis of symmetry. As a result, the largest possible resistance against unintentional release of the attachment is obtained no matter at which position the pull-off force is applied. For some designs of attachments and co-operating main housings of a personal care device, an unintentional off-center pull-off force may be more likely to be applied at one side of the attachment than at the other. In such a case, it may be more advantageous to use a design in which the sloped surface is arranged off-set from an axis of symmetry of the coupling recess.

In embodiments having a symmetrically shaped coupling recess, the sloped surface may be bordered by a first edge at a location where the sloped surface borders the first recessed side portion and by a second edge at a location where the sloped surface borders the second recessed side portion, said first and second edges being directed inwardly, seen from the circumferential surface.

Such inwardly directed first and second edges may extend parallel to each other. In such embodiments, the sloped surface may form an upper surface of a rib-shaped central support member bordered by the first and second edges.

Alternatively, the first and second edges may extend non-parallel to each other and have a smallest mutual distance near, such as at, the circumferential surface of the shaft-like element. Alternatively, the first and second edges may extend non-parallel to each other and have a largest mutual distance near, such as at, the circumferential surface of the shaft-like element.

In some embodiments of the invention, the sloped surface is plane. Alternatively, the sloped surface may be curved. The invention also covers embodiments wherein a portion of the sloped surface is plane and another portion of the sloped surface is curved.

In embodiments wherein the sloped surface is bordered by an edge at each location where the sloped surface borders a respective one of the first and second side portions that are recessed relative to the sloped surface, as described above, when seen in a cross section perpendicular to a longitudinal extension of the edge, the edge may have a radius of curvature from 0 to 5 mm, such as from 0 to 1 mm or from 1 to 2 mm, preferably from 0.1 to 0.5 mm, along at least a part of the longitudinal extension.

In preferred embodiments of the invention, the shaft-like element comprises two coupling recesses, each having the characteristic features according to the invention, arranged on regions of the circumferential surface of the shaft-like element which are mutually opposite relative to the central axis. This means that an attachment according to the present invention can be used in personal care devices, such as the shaving device disclosed in WO 2008/062339. By having two coupling recesses in mutually opposite positions, a more stable mounting of the attachment on the main housing is ensured, particularly for personal care devices with attachments that perform a treatment action involving a rotational movement. Furthermore, two coupling recesses in mutually opposite positions imply the use of two associated spring elements, or two arms or legs of a single spring element as shown in the figures. This results in a more efficient relationship between the retaining force and the required pull-off force to release the attachment. In embodiments having two coupling recesses in mutually opposite positions, the two coupling recesses may be identical or different. This may be determined as part of the design process of the attachment.

In some embodiments of the invention, the attachment, when coupled to the personal care device, is solely supported by the coupling member. As a result, it is ensured that, in case a large external load is applied on the attachment such as due to the personal care device falling on the floor, the coupling member is released from the coupling structure, so that damage to the attachment or the treatment member is limited. This will be explained in further detail in relation to FIG. 4.

In an attachment which is solely supported by the coupling member, as described above, a collar may be provided around the shaft-like element. Such a collar is typically arranged for abutting on an edge provided around the circumference of a retaining recess of the coupling structure which receives the shaft-like element of the coupling member. By providing said collar it is ensured that the coupling member, and thereby the whole attachment, is held in a desired position in the retaining recess, because the spring force provided by the spring element of the coupling structure on the sloped surface of the coupling recess will pull the coupling member towards the base part. This will be more clearly seen in relation to FIG. 4.

In a second aspect, the invention relates to a personal care device comprising:
an attachment according to any one of the embodiments of the first aspect of the invention as described above,
a main housing comprising a coupling structure for releasably coupling with the coupling member of the attachment,
a drive shaft for driving the at least one treatment member of the attachment, and
drive means for driving the drive shaft,
   wherein
   the coupling structure comprises:
a retaining recess for receiving the shaft-like element of the coupling member, and
at least one spring element for engagement with the sloped surface of the at least one coupling recess of the shaft-like element to establish a releasable coupling between the attachment and the main housing. The drive shaft may extend between drive means of the personal care device and the attachment through the shaft-like element. Such drive means typically comprise a motor driven by a battery, such as a rechargeable battery, or connected or connectable to electrical mains.

In general, the various aspects of the invention may be combined in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1a and 1b schematically show three-dimensional views of a known personal care device comprising a detachable attachment;

FIGS. 2a and 2b schematically show three-dimensional views of the attachment of the personal care device of FIG. 1 and a part of the main housing of the personal care device in which the attachment can be releasably retained;

FIGS. 3a and 3b schematically show cross-sectional views of the attachment and the part of the main housing shown in FIGS. 2a and 2b, wherein FIG. 3a shows a detached condition of the attachment, and wherein FIG. 3b shows a coupled condition of the attachment;

FIG. 4a schematically shows a side view of another known coupling member;

FIG. 4b schematically shows a cross-sectional view of a part of a known personal care device comprising the coupling member shown in FIG. 4a in a coupled condition;

FIG. 5 shows computer simulations of the effect of an off-center pull-off force applied on a known coupling member;

FIG. 6 schematically shows a coupling member with a coupling recess of an embodiment of an attachment in accordance with the present invention;

FIG. 7 shows computer simulations of the effect of an off-center pull-off force applied on the coupling member shown in FIG. 6;

FIGS. 8a-8g schematically show coupling members with a coupling recess of various alternative embodiments of an attachment in accordance with the present invention; and

FIG. 9 schematically shows an example of a possible shape of the surface of a coupling recess with a curved, sloped surface.

### DETAILED DESCRIPTION OF THE EMBODIMENTS

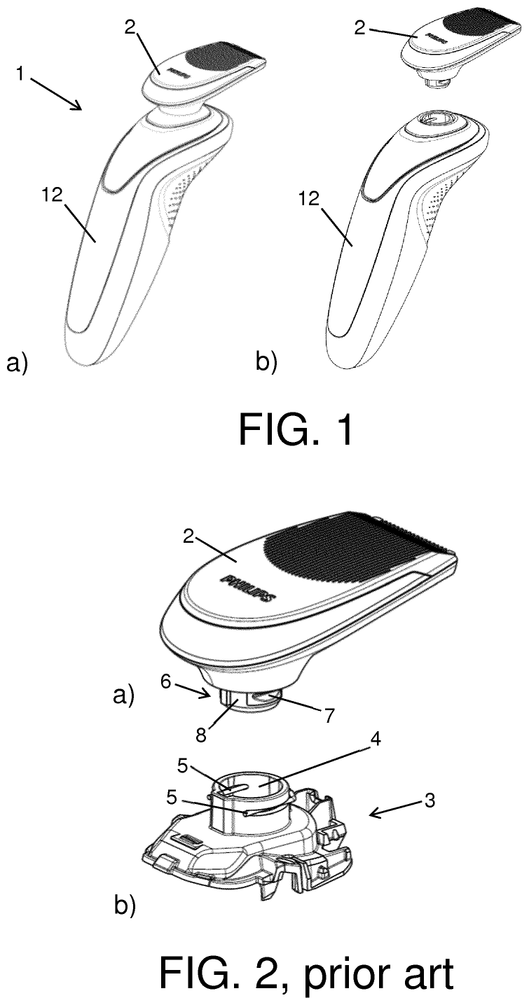

FIGS. 1a and 1b schematically show three-dimensional views of a known personal care device 1 comprising a detachable attachment 2 and a main housing 12. The device shown in these and the following figures is an electric trimmer, but other kinds of devices, such as shavers and massaging devices, are also covered by the present invention.

FIGS. 2a and 2b schematically show three-dimensional views of a known design of a releasable coupling between the attachment 2 and a base part 3 of the main housing 12, exemplified with the trimmer in FIGS. 1a and 1b. FIG. 2a shows the attachment, and FIG. 2b shows an upper part of the base part 3 which comprises a retaining recess 4 for holding the attachment 2. The retaining recess 4 comprises a spring element 5 which, in the illustrated embodiment, is in the form of a bent piece of spring metal, i.e. a spring element bent in a U-shape having two parallel legs. Alternatively, the two spring legs could be embodied as two individual spring elements. As seen in FIG. 2a, the attachment 2 comprises a shaft-like element 6 adapted to engage with and be received by the retaining recess 4. Two coupling recesses 7 (only one of which is visible in FIG. 2a) are located on a circumferential surface 8 of the shaft-like element 6, i.e. in mutually opposite positions relative to a central axis of the shaft-like element 6.

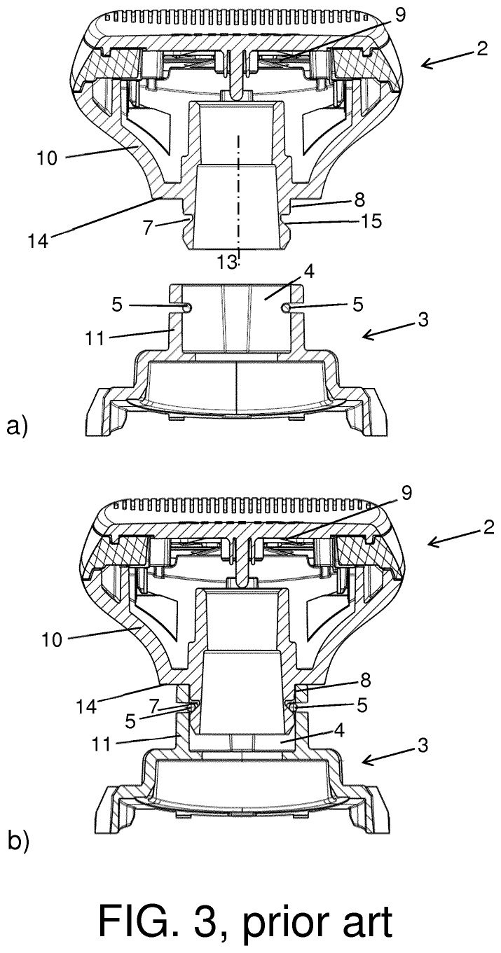

FIGS. 3a and 3b schematically show, in cross-sectional views, the known releasable couplings as shown in FIGS. 2a and 2b along a plane extending through the central axis 13 of the shaft-like element 6. FIG. 3a shows the attachment 2 in a released condition, and FIG. 3b shows the attachment 2 in a condition coupled to the base part 3 of the main housing 12 of the personal care device 1. The attachment 2 comprises at least one treatment member 9 for performing a treatment action. Such a treatment action could e.g. be shaving, in which case the attachment would be a shaving head, e.g. comprising one or more rotary shaving units. Other possible embodiments of the attachment could be a shaving unit with a linearly moving shaving member, a trimming unit in several executions, a unit with rotational brushes e.g. for facial cleaning, or an eye treatment unit. The attachment 2 further comprises a coupling member 10 which is releasably retainable by a coupling structure 11 of the base part 3 of the personal care device 1. The coupling member 10 comprises a shaft-like element 6 having a circumferential surface 8 and a central axis 13. The part of the attachment 2 comprising the at least one treatment member 9 may have any shape at least partly dependent on the treatment action to be performed. The shape shown in FIGS. 1a-3b is schematic only. The shaft-like element 6 protrudes from a surface 14 of the attachment 2, facing the coupling structure 11 in the coupled condition of the attachment, so that it can be engaged with the coupling structure 11. In other words, the shaft-like element 6 protrudes from the attachment 2 in a direction away from the at least one treatment member 9, so that the shaft-like element 6 has an orientation on the attachment 2 which ensures that it is adapted to be received by the retaining recess 4 of the coupling structure 11.

In the embodiment in FIGS. 3a and 3b and in the following figures, the shaft-like element 6 comprises two coupling recesses 7, arranged on regions of the circumferential surface 8 of the shaft-like element 6 which are mutually opposite relative to the central axis 13 of the shaft-like element 6. This arrangement of the two coupling recesses 7 allows the use of the attachment 2 in a personal care device having a main housing with a base part e.g. as disclosed in WO 2008/062339. An alternative design would be a design with only one coupling recess on one side of the circumferential surface of the shaft-like element. The two coupling recesses 7 each comprise a sloped surface 15, said sloped surface 15 being inclined towards the treatment member 9, seen in a direction from the circumferential surface 8 towards the central axis 13. The sloped surfaces 15 of the two coupling recesses 7 are arranged to each engage with respectively one of the two legs of the spring element 5 of the coupling structure 11, so that the attachment 2 is releasably retained in the retaining recess 4 of the coupling structure 11 of the main housing 12 of the personal care device 1.

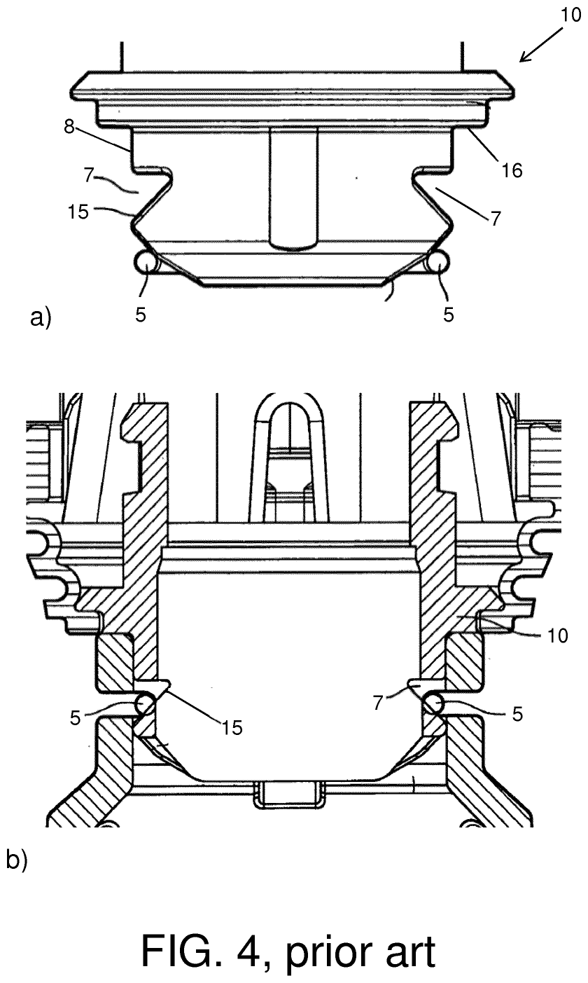

FIG. 4a schematically shows a side view of another known coupling member 10, and FIG. 4b schematically shows a cross-sectional view of a part of the main housing of a known personal care device with the coupling member 10 as shown in FIG. 4a coupled thereto. FIG. 4a shows the coupling member 10 in a condition wherein the lower part of the coupling member 10 is about to engage with the spring element 5 of the coupling structure 11 of the base part 3 of the main housing. To couple the attachment 2 to the main housing, the attachment 2 is pressed downwards starting from the orientation shown in FIG. 4a. As a result, the legs of the spring element 5 are bent elastically in radially outward directions by their interaction with a further sloped surface provided on the bottom portion of the shaft-like element 6, until the legs pass the widest part of the circumferential surface 8 of the shaft-like element 6. By then, the legs engage with the two opposed coupling recesses 7 in a snap-fastening manner as shown in FIG. 4b. The sloped surfaces 15 of the coupling recesses 7 make it possible to release the attachment 2 from its engagement with the legs of the spring element 5 by applying a pulling force on the attachment 2, preferably aligned with the central axis of the shaft-like element.

As shown in FIG. 4b, the attachment 2, when coupled to the main housing of the known personal care device, is solely supported by the coupling member 10. As a result, it is achieved that, when an external load is exerted on the attachment 2 of the personal care device 1, the load is transferred to the coupling member 10. Since, in the coupled state, the attachment 2 is not supported in the area of its outer circumference, the area of the outer circumference of the attachment 2 does not contribute in transferring the external load to the base part 3 of the main housing. As a result, the coupling member 10 solely has to transfer the external load to the base part 3. Since the coupling member 10 is arranged in a relatively narrow central area of the attachment 2, the mechanical torque associated with an external load exerted on the outer circumference of the attachment 2 will lead to a relatively high force on the coupling member 10. If the external load is large enough, the coupling member 10 is released from the coupling structure 11, thereby preventing that an overload would result in damage to the attachment 2 or the treatment member 9. In normal use of the personal care device 1, the coupling member 10 and the coupling structure 11 provide a solid coupling between the attachment 2 and the base part 3 such that a force exerted on the attachment 2 during normal use does not result in release of the coupling member 10. Only if the load on the attachment 2 exceeds a critical value, for example due to an accidental misuse or fall, the coupling member 10, and thus the whole attachment 2, is released from the base part 3.

As also seen in FIGS. 4a and 4b, a collar 16 is provided around the shaft-like element 6 for abutting on an edge around the circumference of the retaining recess 4. The collar 16 abuts the base part 3 when the attachment 2 is attached to the base part 3. While the spring element 5 exerts a spring force on the sloped surfaces 15, the collar 16 prevents a further insertion of the coupling member 10, thus generating a tension force of the spring element 5 on the sloped surface 15 for retaining the coupling member 10 in a fixed position in the retaining recess 4. Further, the collar 16 may prevent dirt and dust from entering into the retaining recess 4 and/or may provide a watertight closure of the base part 3. If the collar 16 is not designed symmetrically, the collar may define an angular orientation of the attachment 2 about the central axis 13 in relation to the base part 3. Alternatively or in combination therewith, a protruding rib on the circumferential surface can be used to ensure a desired angular orientation of the attachment 2.

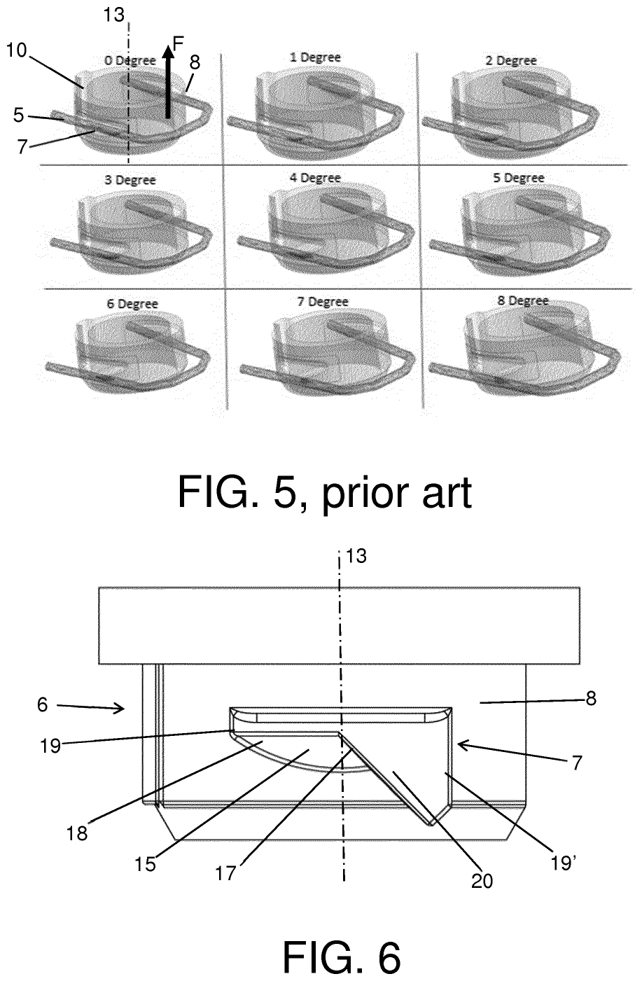

The spring element 5 engages with a relatively large portion of the sloped surfaces 15 of the coupling recesses 7, thereby ensuring a sufficient holding force for retaining the attachment 2 coupled to the base part 3. When the attachment 2 is removed by applying a pulling force which is aligned with the central axis 13, the spring element 5 will glide off the sloped surfaces 15 until it reaches the circumferential surface 8, whereby the attachment 2 is released. However, studies including the use of computer simulations have shown that, when an off-center force F is applied as shown in the first part of FIG. 5, i.e. a force F parallel to but not aligned with the central axis 13, the spring element 5 will not glide off the sloped surface 15 in the intended manner. This is due to the fact that the off-center force gives rise to a torque on the coupling member 10 resulting in a tilting of the coupling member. This tilting will also occur for orientations and points of exertion of the applied force F other than along the central axis 13. The most critical condition occurs when the force F is applied in a plane comprising the central axis 13 and extending parallel to the longitudinal extensions of the two legs of the spring element 5. FIG. 5 shows the results of computer simulations illustrating the process of detachment of the coupling member 10 by application of a force as shown in the first sub-figure, i.e. the figure marked with “0 Degree”. FIG. 5 shows how the tilting of the coupling member 10, and thus of the whole attachment 2, causes the legs of the spring element 5 to glide off the sloped surfaces 15 of the coupling recesses 7, starting at the side portions of the sloped surfaces 15 where the depth of the coupling recesses 7 is relatively small, and to further glide off via the edges between the sloped surfaces 15 and the circumferential surface 8. In this situation, the resulting effective holding force of the spring element 5 on the sloped surfaces 15 is relatively low. In the preferred situation wherein the pulling force is exerted centrally along the central axis 13, the legs of the spring element 5 will glide off more uniformly over the sloped surfaces 15 of the coupling recesses 7, so that the central portions of the sloped surfaces 15, where the coupling recesses 7 have the largest depth, fully contribute to providing resistance against the gliding off of the spring element 5. An off-center pulling force generally does not cause any problem when it is the intention of a user to remove the attachment 2. However, in case of an off-center pulling force during use of the personal care device 1, the attachment 2 can be released from the base part 3 too easily, i.e. with too little force.

The above described problem has been solved by the inventors of the present invention by re-designing the geometry of the coupling recess 7 as will be described in the following. FIG. 6 shows a geometry of a coupling recess 7 in accordance with an embodiment of the present invention. The other features of an attachment for a personal care device according to the invention are as schematically described in relation to the FIGS. 1-5. The coupling recess 7 in FIG. 6 comprises a sloped surface 15 which is partly delimited by an edge 17 directed inwardly seen from the circumferential surface 8, i.e. an edge 17 oriented in a direction towards a central region of the shaft-like element 6. The edge 17 typically has a radius of curvature from 0 to 3 mm, such as from 0 to 1 mm or from 0.5 to 2 mm, preferably from 0.1 to 0.5 mm along at least a part of its longitudinal extension.

In the coupling recess 7 in FIG. 6, the sloped surface 15 extends over a central portion of the coupling recess 7 and over a first side portion 18 of the coupling recess 7 that extends from the central portion up to a first end point 19 of the coupling recess 7. A second side portion 20 of the coupling recess 7 extends from the central portion of the coupling recess 7 to a second end point 19′ of the coupling recess 7. Thus, seen in a cross-section of the shaft-like element 6 perpendicular to the central axis 13, the first and second side portions 18, 20 of the coupling recess 7 are arranged on opposite sides of the central portion and each extend from the central portion up to a respective one of the end points 19, 19′ of the coupling recess 7. The second side portion 20 has a geometry which ensures that it does not engage with the spring element in the coupled condition of the attachment 2. In particular, the sloped surface 15 is bordered by the edge 17 at the location where the sloped surface 15 borders the second side portion 20. As a result, the second side portion 20 of the coupling recess 7 is recessed relative to the sloped surface 15, seen in a direction parallel to the central axis 13. As a result of said recession of the second side portion 20, it is prevented that, in the coupled condition of the attachment 2, the spring element engages the coupling recess 7 at the location of the second side portion 20.

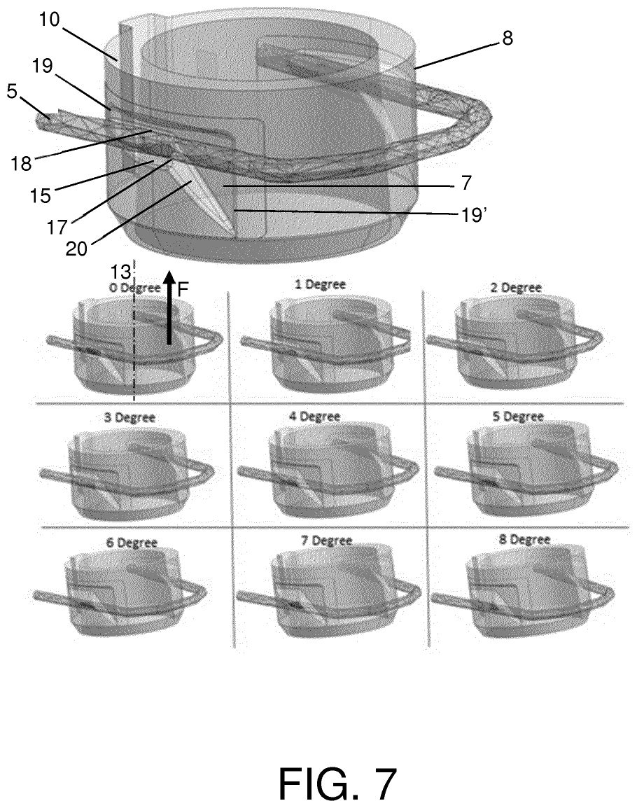

FIG. 7 shows computer simulations of the effects of an off-center pull-off force, resembling the pull-off force in FIG. 5, applied to a coupling member 10 comprising the coupling recess 7 shown in FIG. 6. The simulations show how, with the design of the coupling recess 7 according to the invention, the legs of the spring element glide off along the edge 17, which results in a substantially higher pull-off force as compared to the pull-off force according to the simulations shown in FIG. 5. This means that, with the coupling recess 7 configured in accordance with the present invention, the spring element 5 is more effective with respect to retaining the attachment 2 in the retaining recess 4 in the situation of an off-center pull-off force. At the same time, a centrally applied pull-off force will still result in the intended linear removal of the attachment 2 from the retaining recess 4, which involves a substantial resistance force.

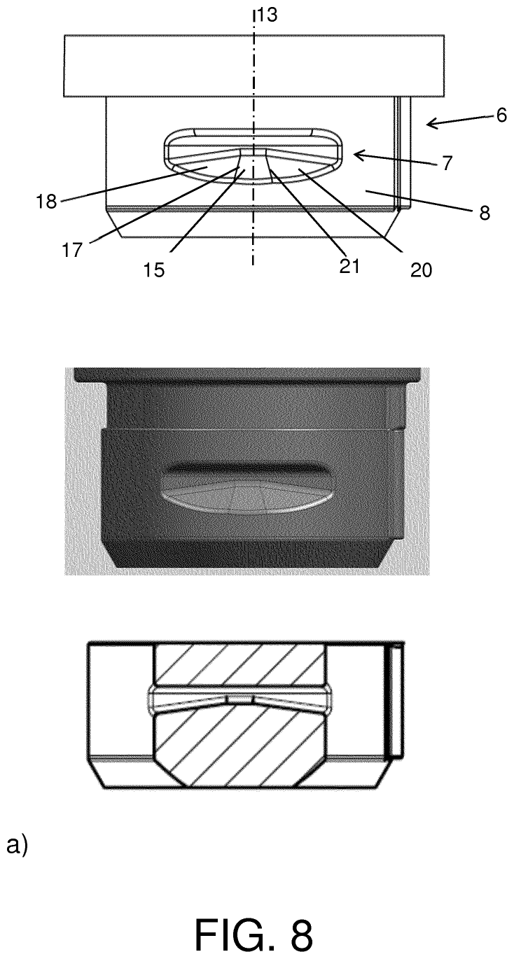

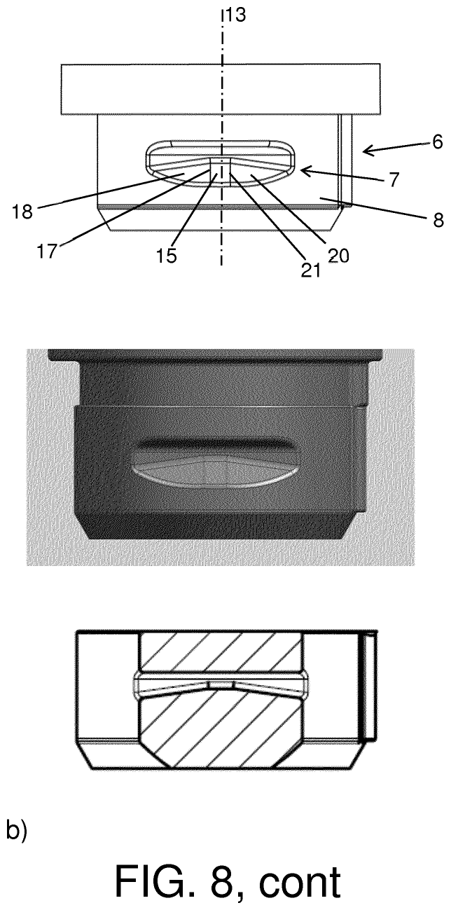

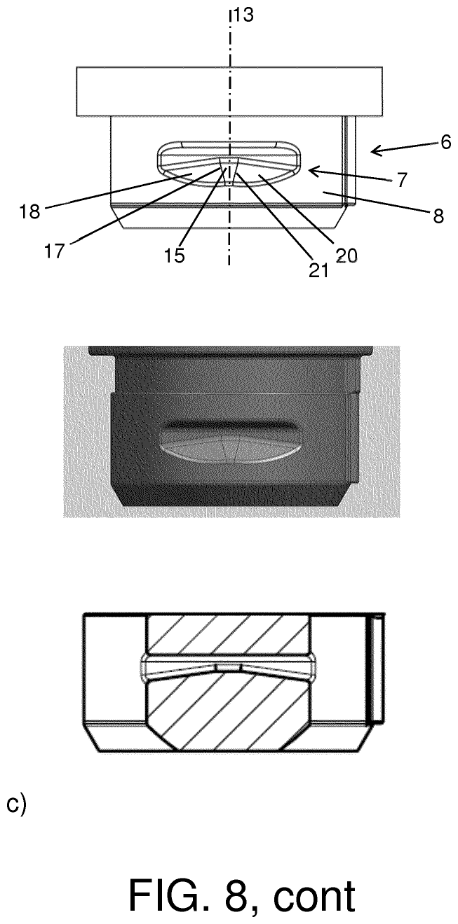

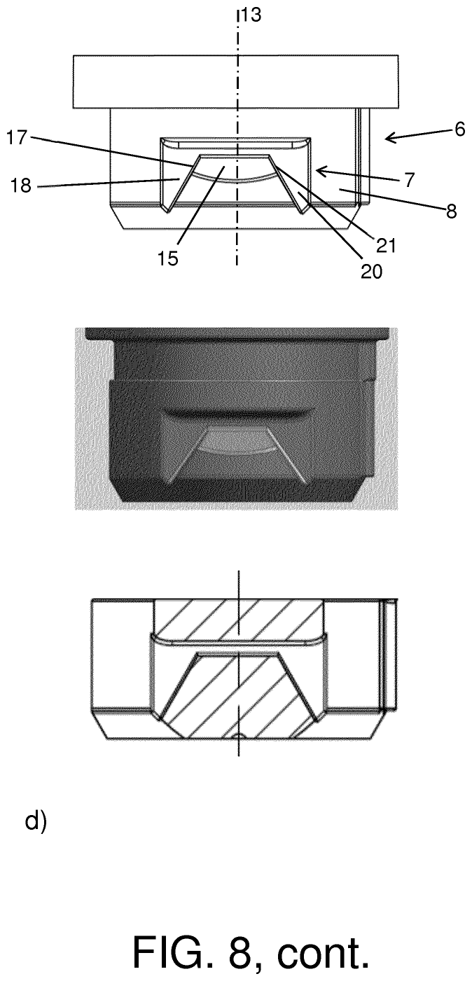

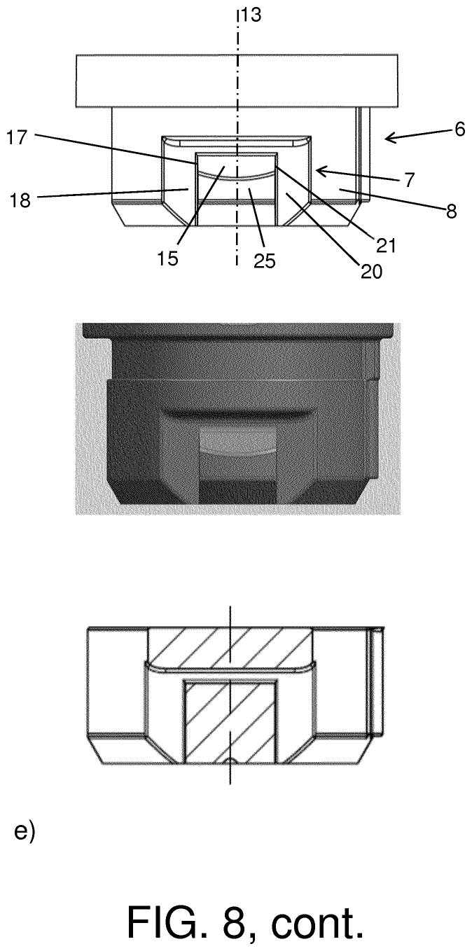

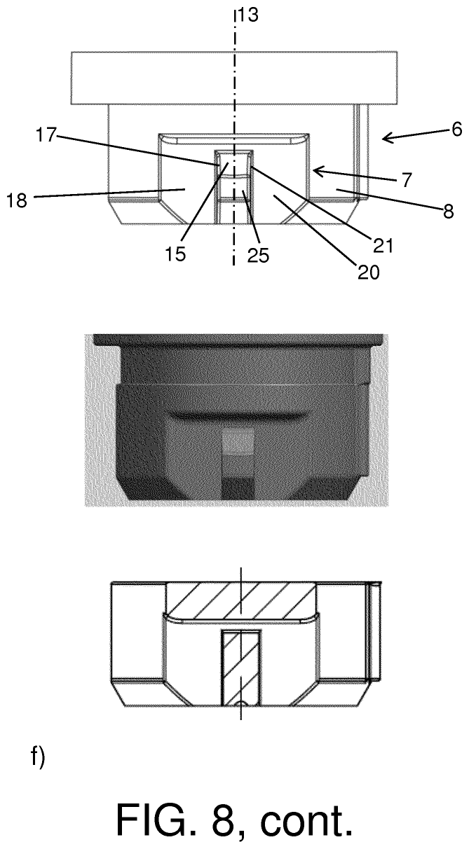

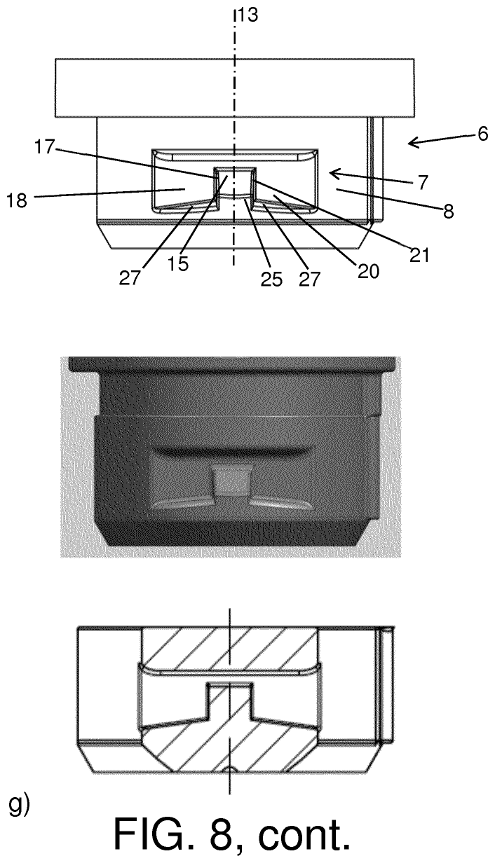

FIGS. 8a-8g schematically show various embodiments of coupling recesses 7 configured in accordance with the present invention. In preferred embodiments, including the embodiments shown in FIGS. 8a-8g, the sloped surface 15 is arranged in the central portion of the coupling recess 7, and the coupling recess 7 is symmetrically shaped relative to an imaginary plane of symmetry comprising the central axis 13 of the shaft-like element 6. The embodiments in FIGS. 8a-8g are all depicted as line drawings, grey scale drawings and cross-sectional views, as the different kinds of illustrations are considered to provide different kinds of information. The cross-sectional views are shown along planes oriented parallel to the central axis 13 at a distance from the circumferential surface 8 of the shaft-like element 6. Thus, for each of the illustrated embodiments, the cross-sectional view shows the profile of the coupling recess 7 in a plane positioned at a distance form the circumferential surface 8 and seen towards the central axis 13. The reference numbers are only added to the first sub-figure of each embodiment to more clearly show the other details in the following sub-figures.

In the embodiments of FIGS. 8a-8g, the first and second side portions 18, 20 of the coupling recess 7 are both recessed relative to the sloped surface 15, seen in the direction parallel to the central axis 13, and the sloped surface 15 is bordered by first and second edges 17, 21 at the location where the sloped surface 15 borders respectively the first and second side portions 18, 20. The first and second edges 17, 21 are directed inwardly seen from the circumferential surface 8. As a result, in the coupled condition of the attachment 2, it is prevented that the spring element engages the coupling recess 7 at the location of both the first and second side portions 18, 20. In the embodiments of FIGS. 8a, 8c and 8d, the first and second edges 17, 21 extend non-parallel with respect to each other, while in the embodiments of FIGS. 8b and 8e-8g, the first and second edges 17, 21 extend parallel with respect to each other. In embodiments wherein the first and second edges 17, 21 extend non-parallel with respect to each other, the first and second edges 17, 21 may have a smallest mutual distance near the circumferential surface 8 of the shaft-like element 6, such as shown in the embodiments in FIG. 8c. Alternatively, in embodiments comprising non-parallel first and second edges 17, 21, the first and second edges 17,21 may have a largest mutual distance near the circumferential surface 8 of the shaft-like element 6, such as shown in the embodiments in FIGS. 8a and 8d.

FIGS. 8e and 8f show embodiments wherein the first and second side portions 18, 20 of the coupling recess 7 are recessed relative to the sloped surface 15, seen in the direction parallel to the central axis 13, to such an extent that the coupling recess 7 at the location of the first and second side portions 18, 20 is not bounded by surfaces of the coupling member 10 in end positions of the coupling recess 7 facing away from the treatment member 9. Thus, in the embodiments shown in FIGS. 8e and 8f, the sloped surface 15 forms an upper surface (in the orientation shown in these figures) of a rib-shaped central support element 25 bordered by the recessed first and second side portions 18, 20. Also in the embodiment of FIG. 8g, the sloped surface 15 forms an upper surface of a rib-shaped central support element 25. In this embodiment, however, in the end positions of the coupling recess 7 facing away from the treatment member 9, the coupling recess 7 is bounded by surfaces 27 of the coupling member 10.

The design of a coupling recess 7 in accordance with the invention will include considerations relating to the need for enough free space to allow the spring element to deform. The design also has to take into account that the material thickness of the shaft-like element between the coupling recesses and a possible hollow space in the central region of the shaft-like element should be large enough to prevent deformation or breakage of the shaft-like element. The design for a given product will typically be based on computer simulations, possibly combined with prototypes made e.g. by 3D-printing.

If a personal care device according to the invention is to be used with different attachments, the coupling recesses of the coupling members of the different attachments can be designed differently, if desired or required. By such different designs, the combination of the necessary pull-off force for an intended release of the attachment and the resistance against unintentional release of the attachment can be optimized for each different attachment, since said pull-off force and resistance are directly dependent on the geometries of the coupling recessess used for the different attachments.

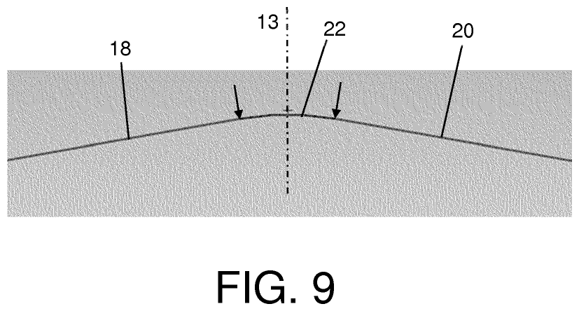

The sloped surfaces 15 in the embodiments shown in the FIGS. 6-8 are plane surfaces. However, the sloped surfaces 15 may also be curved surfaces. An example of a possible shape of a coupling recess 7 with a curved sloped surface 22 is shown schematically in FIG. 9. The curved sloped surface 22 is shown in combination with first and second side portions 18, 20, wherein the first and second side portions 18, 20 comprise surfaces that are inclined at an angle relative the sloped surface 22 to ensure that, in the coupled condition of the attachment 2, there is no contact with the spring element at the location of the first and second side portions 18, 20. FIG. 9 shows the sloped surface 22 and the first and second side portions 18, 20, seen in a direction perpendicular to the central axis 13. In the shown embodiment, the first and second side portions 18, 20 have plane upper surfaces ending where the curved sloped surface 22 begins. The intersection between the curved and plane surfaces are illustrated with arrows in FIG. 9.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A particular unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. Attachment for a personal care device, the attachment comprising:
at least one treatment member for performing a treatment action, and
a coupling member for releasably coupling the attachment to a coupling structure of a main housing of the personal care device,
wherein
the coupling member comprises a shaft-like element:
having a circumferential surface and a central axis,
protruding from the attachment in a direction away from the at least one treatment member, and
comprising at least one coupling recess arranged in a portion of the circumferential surface which is convex at least when seen in a cross-section of the shaft-like element perpendicular to the central axis,
and wherein
the at least one coupling recess, when seen in the cross-section of the shaft-like element perpendicular to the central axis, has a central portion and first and second side portions arranged on opposite sides of the central portion and each extending from the central portion up to an end point of the coupling recess, and
the at least one coupling recess comprises a sloped surface arranged in at least the central portion, said sloped surface being inclined towards the treatment member seen in a direction from the circumferential surface towards the central axis,
and wherein
at least one of the first and second side portions of the coupling recess is recessed relative to the sloped surface, seen in a direction parallel to the central axis.

2. Attachment according to claim 1, wherein the sloped surface is bordered by an edge at each location where the sloped surface borders a respective one of the first and second side portions that are recessed relative to the sloped surface, said edge being directed inwardly seen from the circumferential surface.

3. Attachment according to claim 1, wherein the at least one coupling recess is symmetrically shaped relative to an imaginary plane of symmetry comprising the central axis of the shaft-like element, the first and second side portions being both recessed relative to the sloped surface, seen in the direction parallel to the central axis.

4. Attachment according to claim 3, wherein the sloped surface is bordered by a first edge at a location where the sloped surface borders the first recessed side portion and by a second edge at a location where the sloped surface borders the second recessed side portion, said first and second edges being directed inwardly seen from the circumferential surface.

5. Attachment according to claim 4, wherein the first and second edges extend parallel to each other.

6. Attachment according to claim 5, wherein the sloped surface forms an upper surface of a rib-shaped central support element bordered by the first and second edges.

7. Attachment according to claim 4, wherein the first and second edges extend non-parallel to each other and have a smallest mutual distance near the circumferential surface of the shaft-like element.

8. Attachment according to claim 4, wherein the first and second edges extend non-parallel to each other and have a largest mutual distance near the circumferential surface of the shaft-like element.

9. Attachment according to claim 1, wherein the sloped surface is plane.

10. Attachment according to claim 2, wherein, seen in a cross section perpendicular to a longitudinal extension of the edge, the edge has a radius of curvature from 0 to 5 mm, such as from 0 to 1 mm or from 1 to 2 mm, preferably from 0.1 to 0.5 mm along at least a part of the longitudinal extension.

11. Attachment according to claim 1, wherein the shaft-like element comprises two coupling recesses arranged on regions of the circumferential surface of the shaft-like element which are mutually opposite relative to the central axis.

12. Attachment according to claim 1, wherein the attachment, when coupled to the personal care device, is solely supported by the coupling member.

13. Attachment according to claim 1, wherein a collar is provided around the shaft-like element.

14. Personal care device comprising:
an attachment according to claim 1,
a main housing comprising a coupling structure for releasably coupling with the coupling member of the attachment,
a drive shaft for driving the at least one treatment member of the attachment, and
drive means for driving the drive shaft,
wherein
the coupling structure comprises:
a retaining recess for receiving the shaft-like element of the coupling member, and
at least one spring element for engagement with the sloped surface of the at least one coupling recess of the shaft-like element to establish a releasable coupling between the attachment and the main housing.

15. Personal care device according to claim 14, wherein the drive shaft extends, between the drive means and the attachment, through the shaft-like element.
